(19) United States
(12) Patent Application Publication
(10) Pub. No.: US 2025/0385979 A1
(43) Pub. Date: Dec. 18, 2025

(54) DOCUMENT SCANNER AND DOCUMENT SCANNING METHOD WITH BOUNDARY JUDGING FUNCTION

(71) Applicant: AVISION INC., Hsinchu (TW)

(72) Inventor: Chun-Chieh LIAO, Hsinchu City (TW)

(21) Appl. No.: 19/007,716

(22) Filed: Jan. 2, 2025

(30) Foreign Application Priority Data
Jun. 12, 2024 (TW) 113121606

(51) Int. Cl. H04N 1/00; H04N 1/028

(52) U.S. Cl. CPC H04N 1/00684; H04N 1/00737; H04N 1/02815

(57) ABSTRACT

In a document scanner, a housing has a transparent platen for supporting a document, and a driving mechanism drives a light source and an image sensor to move relatively to the transparent platen. In a light-emitting mode, a processor controls the light source to emit light to the document, and controls the image sensor to receive light and obtain a first image having first pixels. In a non-emitting mode, the processor controls the light source not to emit light, and controls the image sensor to receive light and obtain a second image having second pixels, wherein the second pixels respectively correspond to the first pixels. The processor judges whether a difference between a first visible light channel value of the first pixel and a second visible light channel value of the second pixel corresponding to the first pixel is greater than a threshold value to judge the first pixel as being corresponding to a document part or a non-document part. A document scanning method is also disclosed.

### CROSS-REFERENCE TO RELATED APPLICATIONS

This application claims priority of No. 113121606 filed in Taiwan R.O.C. on Jun. 12, 2024 under 35 USC 119, the entire content of which is hereby incorporated by reference.

### FIELD OF THE INVENTION

This disclosure relates to a document scanner and a document scanning method, and more particularly to a document scanner and a document scanning method with a boundary judging function.

### DESCRIPTION OF RELATED ART

Today's multi-function peripheral includes a flatbed document scanner and a printer. When a document is being scanned, an upper cover is usually closed to press the document and keep the flatness of the document, and also to provide a white background, so that the black boundary image not pertaining to the document can be removed from the scanned image, and the waste of the toner or ink upon printing can be reduced. In order to achieve the automatic boundary cropping function in another flatbed document scanner, an upper cover with a dark background is usually provided to press the document, so that there is clear contrast between the document, having the white background, and the dark background, and the automatic boundary cropping function can be achieved. However, a dark card/document cannot be correctly cropped in the condition where a dark background element is used.

However, when the document, such as a book having a large thickness, is scanned, the upper cover cannot be closed, the automatic boundary cropping function cannot be achieved, and the user needs to manually perform the boundary cropping, or to design a frame to fit with a specific book in a quite troublesome manner.

Therefore, the above-mentioned problems need to be solved.

### SUMMARY OF THE INVENTION

It is therefore an objective of this disclosure to provide a document scanner and a document scanning method with a boundary judging function. An external environment light source is used in conjunction with the switching between a light-emitting mode and a non-emitting mode of the document scanner to obtain two images. Visible light channel values of pixels of the two images are judged to obtain reference data for automatic boundary cropping, or even an actual image corresponding to the document can be automatically cropped.

To achieve the above-identified objective, this disclosure provides a document scanner including a housing, a light source, an image sensor, a driving mechanism and a processor. The housing has a transparent platen for supporting a document. The light source, the image sensor and the driving mechanism are disposed in the housing, and the driving mechanism drives the light source and the image sensor to move relatively to the transparent platen. The processor is electrically connected to the light source, the image sensor and the driving mechanism. In a light-emitting mode, the processor controls the light source to emit light to the document, and controls the image sensor to receive light and obtain a first image having first pixels. Each of the first pixels has a first visible light channel value. In a non-emitting mode, the processor controls the light source not to emit light, and controls the image sensor to receive light and obtain a second image having second pixels. Each of the second pixels has a second visible light channel value, wherein the second pixels respectively correspond to the first pixels. The processor judges whether a difference between the first visible light channel value of the first pixel and the second visible light channel value of the second pixel corresponding to the first pixel is greater than a threshold value. The first pixel is judged as being corresponding to a document part of the document if the difference is greater than the threshold value, and the first pixel is judged as being corresponding to a non-document part other than the document if the difference is not greater than the threshold value.

This disclosure also provides a document scanning method used in a document scanner. The document scanning method includes: controlling a light source to emit light to a document, and controlling an image sensor to receive light and obtain a first image having first pixels, wherein each of the first pixels has a first visible light channel value; controlling the light source not to emit light, and controlling the image sensor to receive light and obtain a second image having second pixels, wherein each of the second pixels has a second visible light channel value, the second pixels correspond to the first pixels, respectively; and judging whether a difference between the first visible light channel value of the first pixel and the second visible light channel value of the second pixel corresponding to the first pixel is greater than a threshold value, judging the first pixel as being corresponding to a document part of the document if the difference is greater than the threshold value, and judging the first pixel as being corresponding to a non-document part other than the document if the difference is not greater than the threshold value.

With the above-mentioned embodiment, the document part and the non-document part can be judged or determined according to the judgment expression relating to the difference between the first visible light channel value and the second visible light channel value. The position of the document can be determined and the document can be cropped very conveniently without closing an upper cover and without being affected by the external light, and the problem that a dark card/document cannot be correctly cropped in the condition where a dark background element is present. Thus, this disclosure performs the automatic boundary cropping according to the judgment expression, which is suitable for the book scanning and also applicable to the non-book scanning without the need of the penetration light source for assisting in judging the boundary. This function can be provided as long as the document scanner has the above-mentioned controlling and processing methods, and the application is very convenient.

In order to make the above-mentioned content of this disclosure more obvious and be easily understood, preferred embodiments will be described in detail as follows in conjunction with the accompanying drawings.

### BRIEF DESCRIPTION OF DRAWINGS

FIG. 1 is a schematic view showing a document scanner according to a preferred embodiment of this disclosure.

FIG. 2 is a schematic view showing a first image and a second image of FIG. 1.

FIG. 3 is a schematic view showing a modified example of FIG. 1.

FIG. 4 is a flow chart showing a document scanning method according to the preferred embodiment of this disclosure.

FIG. 5 shows an actual example of the first image.

FIG. 6 shows an actual example of the second image.

FIG. 7 shows an actual example of a third image.

### DETAILED DESCRIPTION OF THE INVENTION

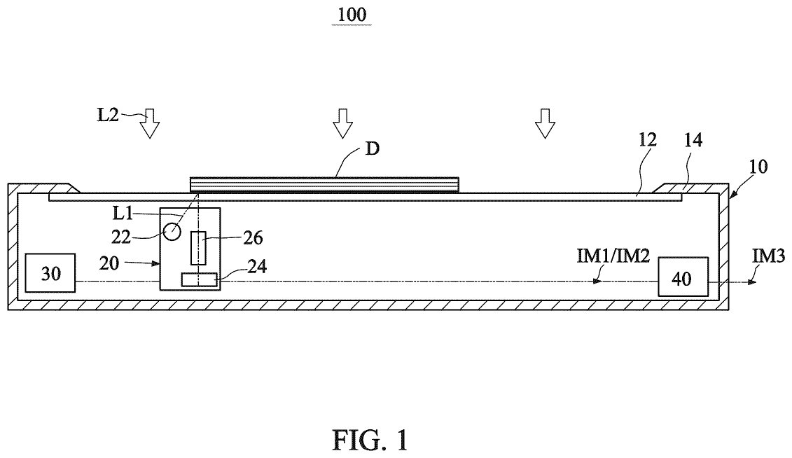

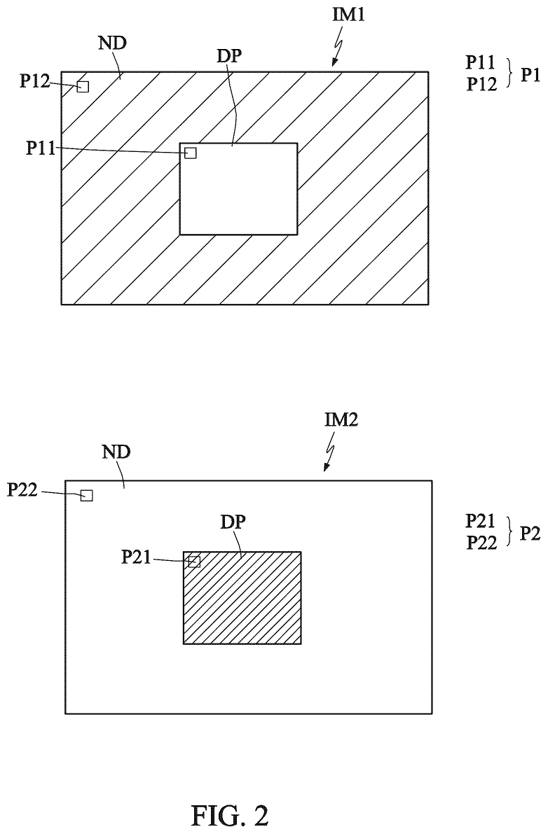

FIG. 1 is a schematic view showing a document scanner 100 according to a preferred embodiment of this disclosure. FIG. 2 is a schematic view showing a first image and a second image of FIG. 1. Referring to FIGS. 1 and 2, the document scanner 100 includes a housing 10, a light source 22, an image sensor 24, a driving mechanism 30 and a processor 40. The processor 40 is electrically connected to the light source 22, the image sensor 24 and the driving mechanism 30.

The housing 10 has a transparent platen 12 for supporting a document D. The transparent platen 12 is mounted on an inner surface of a body structure 14. The light source 22, the image sensor 24 and the driving mechanism 30 are disposed in the housing 10. The driving mechanism 30 drives the light source 22 and the image sensor 24 to move relatively to the transparent platen 12. The processor 40 is electrically connected to the light source 22, the image sensor 24 and the driving mechanism 30. The processor 40 has the processing and controlling functions, and may be a processor in a general document scanner and has the programmable function. A lens module 26 is disposed on an optical path between the light source 22 and the image sensor 24. The light source 22, the image sensor 24 and the lens module 26 may be referred to as an optical module 20, such as a contact image sensor (CIS) optical module.

In this embodiment, the document scanner 100 does not include an upper cover so that the cost can be lowered. Alternatively, the upper cover is not closed to press the document when document scanning is being performed. For example, the document may be a book having a predetermined thickness. In another example, the document has one single page. In order to achieve the automatic cropping function, the firmware in the processor 40 of the document scanner 100 is configured to operate in a light-emitting mode and a non-emitting mode.

In the light-emitting mode, the processor 40 controls the light source 22 to emit light to the document D, and controls the image sensor 24 to receive light and obtain a first image IM1 having first pixels P1. Each of the first pixels P1 has a first visible light channel value represented by C1.

In the non-emitting mode, the processor 40 controls the light source 22 not to emit light, and controls the image sensor 24 to receive light and obtain a second image IM2 having second pixels P2. Each of the second pixels P2 has a second visible light channel value represented by C2. The second pixels P2 correspond to the first pixels P1, respectively. For the convenience of explaining the following examples, first pixels P11 and P12 are the first pixels P1 in different regions, and second pixels P21 and P22 are the second pixels P2 in different regions.

Next, the processor 40 judges whether a difference (C1−C2) between the first visible light channel value of the first pixel P1 and the second visible light channel value of the second pixel P2 corresponding to the first pixel P1 is greater than a threshold value (TH). If yes (C1−C2>TH), then the first pixel P1 is judges as being corresponding to a document part DP of the document D. If not (C1−C2≤TH), then the first pixel P1 is judged as being corresponding to a non-document part ND other than the document D.

Therefore, when the upper cover is not closed, it is possible to judge which pixels pertain to the document part, and which pixels pertain to the non-document part according to the first and second images obtained in the light-emitting mode and the non-emitting mode, so that the automatic cropping information can be obtained. In one example, the first image, the second image and judgment results of the document part and the non-document part can be outputted to an external device (not shown, such as a computer), which performs automatic boundary cropping. In another example, the processor 40 combines multiple ones of the first pixels P1 corresponding to the document part DP of the document D into a third image IM3 to be outputted to the external device and directly applied by the external device, so that the data transmission quantity can be reduced.

When the upper cover is not closed, document scanning is performed using the environment light source. Therefore, in the light-emitting mode, the processor 40 controls the light source 22 to output scan light L1 from a location below the document D, so that the image sensor 24 disposed below the document D and the transparent platen 12 receives the scan light L1, reflected by the document D, and environment light L2, coming from a location above the document D and penetrating through the transparent platen 12, and obtains the first image IM1. In addition, in the non-emitting mode, the image sensor 24 receives the environment light L2 penetrating through the transparent platen 12 and obtains the second image IM2.

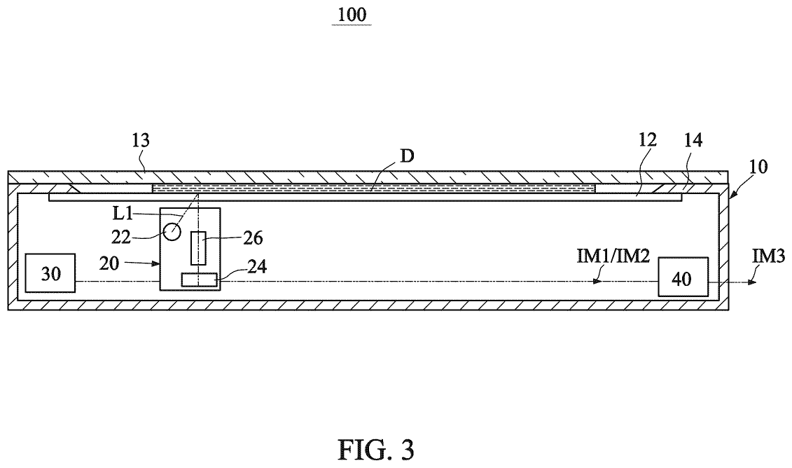

FIG. 3 is a schematic view showing a modified example of FIG. 1. Although this embodiment is designed in a condition where the upper cover is not closed, the present inventor has found that this embodiment is applicable to the condition where the upper cover having a dark background element 13 is closed. Regarding this case, in the light-emitting mode, the processor 40 controls the light source 22 to output the scan light L1 from a location below the document D so that the image sensor 24 disposed below the document D and the transparent platen 12 receives the scan light L1, reflected by the document D and the background element 13 for pressing the document D against the transparent platen 12, and obtains the first image IM1. In the non-emitting mode, the image sensor 24 performs scanning in a condition without light and obtains the second image IM2, and the judgment expression (C1−C2>TH) is also applicable.

Theoretically, in the condition without closing the upper cover, and in a condition of an 8-bit visible light channel value (the visible light channel value ranges from 0 to 255), the background element is not present, TH may be configured to 0, and the following Table 1 can be explained.

TABLE 1

| Condition | Document part | Non-document part |
|---|---|---|
| light-emitting mode: | first pixel P11 has | first pixel P12 has |
| light is on; and | C1 = 200 | C1 = 100 |
| environment light is | | |
| present | | |
| non-emitting mode: | second pixel P21 has | second pixel P22 has |
| light is off; and | C2 = 0 | C2 = 100 |
| environment light is | | |
| present | | |
| judgment result and | 200 − 0 > 0, | 100 − 100 = 0, |
| post-processing | pertaining to the | pertaining to the non- |
| | document part; keep the | document part; set the |
| | visible light channel | visible light channel |
| | value of the first | value of the first pixel |
| | pixel P11 | P12 to 255 or 0 |

In addition, in the condition where the upper cover is closed (i.e., the dark background element is present), the following Table 2 can be explained.

TABLE 2

| Condition | Document part | Non-document part |
|---|---|---|
| light-emitting mode: | first pixel P11 has | first pixel P12 has |
| light is on; and | C1 = 200 | C1 = 0 |
| environment light is | | |
| not present | | |
| non-emitting mode: | second pixel P21 has | second pixel P22 has |
| light is off; and | C2 = 0 | C2 = 0 |
| environment light is | | |
| not present | | |
| judgment result and | 200 − 0 > 0, | 0 − 0 = 0, |
| post-processing | pertaining to the | pertaining to the non- |
| | document part; keep the | document part; set the |
| | visible light channel | visible light channel |
| | value of the first | value of the first pixel |
| | pixel P11 | P12 to 255 or 0 |

Therefore, the above-mentioned judgment expression is applicable to judgment of the document part and the non-document part, according to which edges of the document can be obtained, and the automatic edge cropping effect can be achieved.

In the practical application, however, light reflecting and transmitting properties of the documents may have slight errors. So, TH may be configured as ranging from 5 to 25, preferably ranging from 10 to 20. In one application example, TH=15.

The light-emitting mode and the non-emitting mode may be performed in stages (e.g., in a line-by-line manner, wherein the line is a scan line). That is, after the driving mechanism 30 has driven the light source 22 and the image sensor 24 to move relatively to the transparent platen 12 by a distance, the light-emitting mode and the non-emitting mode are alternately entered to perform a line-by-line scan operation. Therefore, the image sensor 24 has a forward stroke and a backward stroke, and the light-emitting mode and the non-emitting mode are alternately switched in the forward stroke. This can be achieved by the hardware working in conjunction with the firmware design, and the advantage thereof is that the alignment becomes more precise. Because the electronic switching speed is high and the backward stroke of the image sensor 24 can be achieved by the highest speed, the overall speed is also higher. In this case, the light source 22 can be switched fast, and the user cannot find any change in operating conditions. In addition, the third image may also be outputted in a line-by-line manner, so that the real-time processing effect can be achieved without the need of much buffer memory space.

In another example, the light-emitting mode and the non-emitting mode may be entered in two strokes, respectively, such as the forward stroke and the backward stroke. In this case, the driving mechanism 30 drives the light source 22 and the image sensor 24 to enter the light-emitting mode in one of the forward stroke and the backward stroke, and to enter the non-emitting mode in the other one of the forward stroke and the backward stroke.

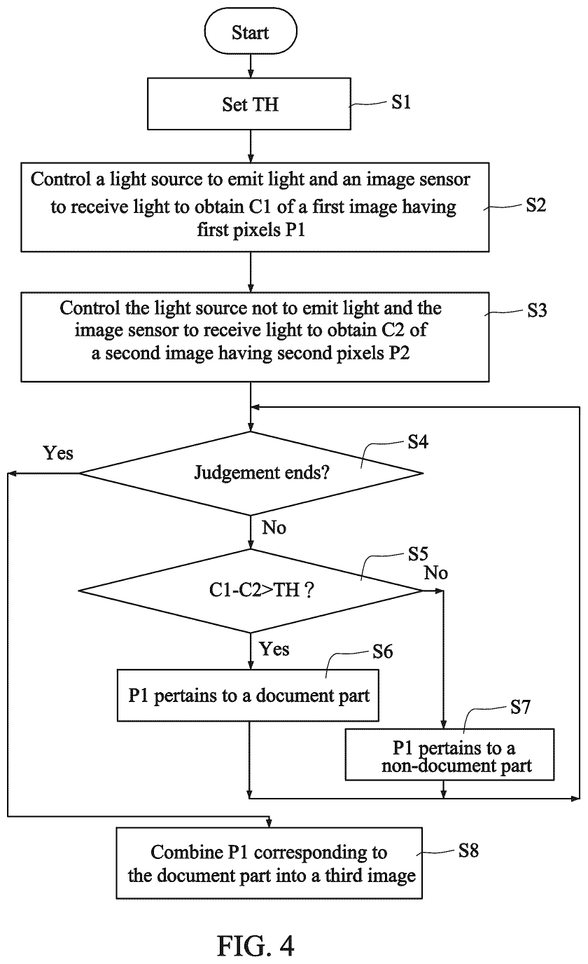

FIG. 4 is a flow chart showing a document scanning method according to the preferred embodiment of this disclosure. Referring to FIGS. 4, 1 and 2, the document scanning method is used in the document scanner 100. The document scanning method includes the following steps S1 to S8.

First, in the step S1, TH is set. This setting may be made before the document scanner 100 is shipped out or when the document scanner 100 is returned to the factory. Of course, the setting may also be made by the user. So, the step S1 is not an essential step.

In the step S2, the light source 22 is controlled to emit light to the document D, and the image sensor 24 is controlled to receive light to obtain C1 of the first image IM1 having the first pixels P1.

In the step S3, the light source 22 is controlled not to emit light, and the image sensor 24 is controlled to receive light and obtain C2 of the second image IM2 having the second pixels P2.

In the step S4, it is judged whether the overall process ends. If yes, the step S8 is performed. If not, the step S5 is performed.

In the step S5, it is judged whether (C1−C2>TH) is true. If yes, the step S6 is performed to judge the first pixel P1 as pertaining to the document part. If not, the step S7 is performed to judge the first pixel P1 as pertaining to the non-document part.

In the step S8, multiple ones of the first pixels P1 corresponding to the document part DP of the document D are combined into the third image IM3.

In another example, when all of the first pixels P1 have been determined as corresponding to the document part DP, the process may return to the step S1 to adjust the threshold value TH, and re-judges whether the difference between C1 of the first pixel P1 and C2 of the second pixel P2 corresponding to the first pixel P1 is greater than the threshold value TH. With this, it is possible to prevent the problem of the boundary judging failure caused by the environment light variation.

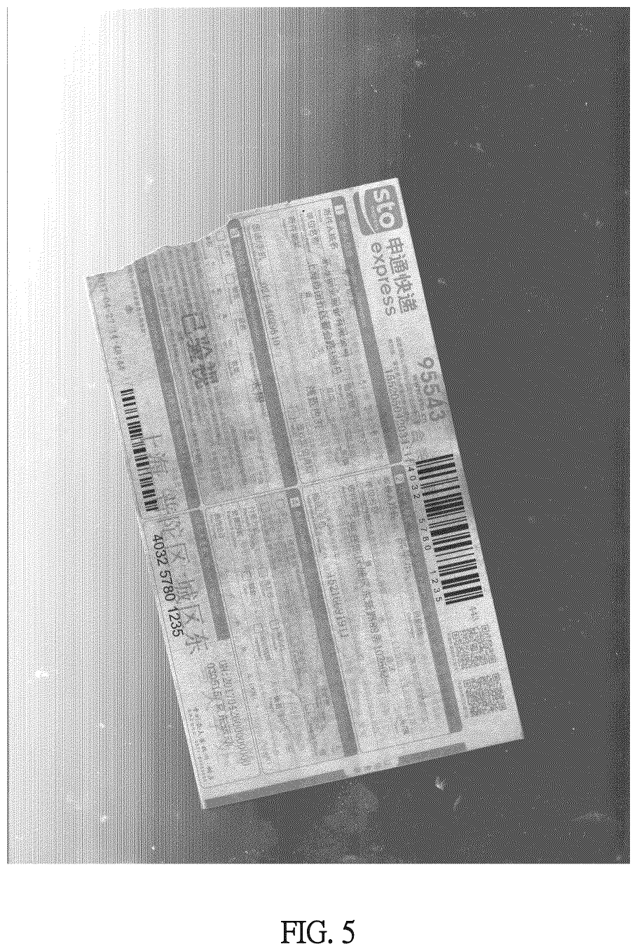

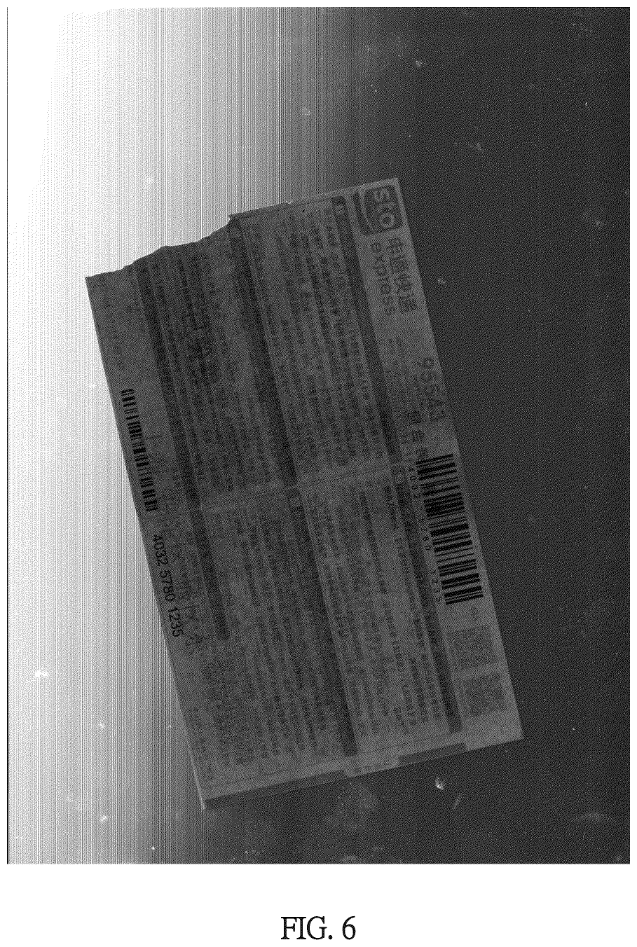

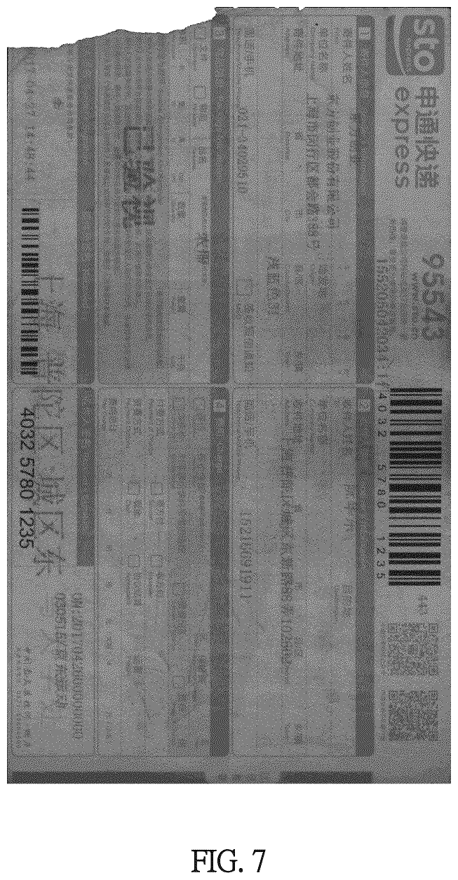

FIGS. 5 to 7 show actual examples of the first image, the second image and the third image, respectively. FIG. 5 shows the first image obtained by performing scanning in the light-emitting mode when the upper cover is not closed, wherein it can be seen that the uniformity of the environment light is not high. FIG. 6 shows the second image obtained by performing scanning in the non-emitting mode when the upper cover is not closed, wherein it can be seen that the part corresponding to the document is darker rather than completely black because the environment light partially penetrates into the range of the document. FIG. 7 shows the third image obtained after the above-mentioned judgment expression is performed according to the results of FIGS. 5 and 6, wherein it can be seen that the boundary of the document has been correctly determined, and the automatic boundary cropping is performed.

It is understandable that although FIGS. 5 to 7 are explained according to gray scale images, FIGS. 5 and 7 may also have color images. Therefore, when the first image is being obtained, the red (R), green (G), blue (B), black-and-white (W) channels, all of which are referred to as RGBW channels, or RGB channels of the image sensor may be enabled or opened, so that the first image of FIG. 5 is the color image. When the second image is being obtained, one of the RG BW channels of the image sensor may be enabled or opened to obtain the gray scale image, so that the scanning can be speeded up.

In addition, although the irregular part at the upper left corner in FIG. 7 is shown by the white color, the irregular part may also be outputted as the transparent information in another example, or displayed by the fully black color or the information capable of providing the obvious difference.

With the above-mentioned embodiment of this disclosure, the document part and the non-document part can be judged or determined according to the judgment expression (C1−C2>TH). Although it might become easy under the description of this disclosure, no such similar solution has been proposed by those skilled in the art for a long period of time. Thus, this disclosure performs the automatic boundary cropping according to the judgment expression, which is suitable for the book scanning and also applicable to the non-book scanning without the need of the penetration light source for assisting in judging the boundary. This function can be provided as long as the document scanner has the above-mentioned controlling and processing methods, and the application is very convenient.

The specific embodiments proposed in the detailed description of this disclosure are only used to facilitate the description of the technical contents of this disclosure, and do not narrowly limit this disclosure to the above-mentioned embodiments. Various changes of implementations made without departing from the spirit of this disclosure and the scope of the claims are deemed as falling within the following claims.

1. A document scanner, comprising:
a housing having a transparent platen for supporting a document;
a light source, an image sensor and a driving mechanism disposed in the housing, wherein the driving mechanism drives the light source and the image sensor to move relatively to the transparent platen; and
a processor electrically connected to the light source, the image sensor and the driving mechanism, wherein:
in a light-emitting mode, the processor controls the light source to emit light to the document, and controls the image sensor to receive light and obtain a first image having first pixels, wherein each of the first pixels has a first visible light channel value;
in a non-emitting mode, the processor controls the light source not to emit light, and controls the image sensor to receive light and obtain a second image having second pixels, wherein each of the second pixels has a second visible light channel value, and the second pixels correspond to the first pixels, respectively; and
the processor judges whether a difference between the first visible light channel value of the first pixel and the second visible light channel value of the second pixel corresponding to the first pixel is greater than a threshold value, wherein the first pixel is judged as being corresponding to a document part of the document if the difference is greater than the threshold value, and the first pixel is judged as being corresponding to a non-document part other than the document if the difference is not greater than the threshold value.

2. The document scanner according to claim 1, wherein the processor combines multiple ones of the first pixels corresponding to the document part of the document into a third image.

3. The document scanner according to claim 1, wherein:
in the light-emitting mode, the processor controls the light source to output scan light from a location below the document, so that the image sensor disposed below the document and the transparent platen receives the scan light, reflected by the document, and environment light, coming from a location above the document and penetrating through the transparent platen, and obtains the first image; and
in the non-emitting mode, the image sensor receives the environment light, penetrating through the transparent platen, and obtains the second image.

4. The document scanner according to claim 1, wherein:
in the light-emitting mode, the processor controls the light source to output scan light from a location below the document, so that the image sensor disposed below the document and the transparent platen receives the scan light, reflected by the document and a background element for pressing the document against the transparent platen, and obtains the first image.

5. The document scanner according to claim 1, wherein in a condition of an 8-bit visible light channel value, the threshold value ranges from 5 to 25.

6. The document scanner according to claim 1, wherein after the driving mechanism has driven the light source and the image sensor to move by a distance relatively to the transparent platen, the light-emitting mode and the non-emitting mode are entered to perform a line-by-line scan operation.

7. The document scanner according to claim 1, wherein the driving mechanism drives the light source and the image sensor to enter the light-emitting mode in one of a forward stroke and a backward stroke, and to enter the non-emitting mode in the other one of the forward stroke and the backward stroke.

8. A document scanning method used in a document scanner, the document scanning method comprising:
controlling a light source to emit light to a document, and controlling an image sensor to receive light and obtain a first image having first pixels, wherein each of the first pixels has a first visible light channel value;
controlling the light source not to emit light, and controlling the image sensor to receive light and obtain a second image having second pixels, wherein each of the second pixels has a second visible light channel value, and the second pixels correspond to the first pixels, respectively; and
judging whether a difference between the first visible light channel value of the first pixel and the second visible light channel value of the second pixel corresponding to the first pixel is greater than a threshold value, judging the first pixel as being corresponding to a document part of the document if the difference is greater than the threshold value, and judging the first pixel as being corresponding to a non-document part other than the document if the difference is not greater than the threshold value.

9. The document scanning method according to claim 8, further comprising:
combining multiple ones of the first pixels corresponding to the document part of the document into a third image.

10. The document scanning method according to claim 8, wherein when all of the first pixels are determined as the document part, the threshold value is adjusted, and re-judging whether the difference between the first visible light channel value of the first pixel and the second visible light channel value of the second pixel corresponding to the first pixel is greater than the threshold value.
